(19) United States
(12) Patent Application Publication
(10) Pub. No.: US 2002/0073181 A1
(43) Pub. Date: Jun. 13, 2002

(54) Lan configurator

(76) Inventor: Tracylee Christensen, Hull, MA (US)

Correspondence Address: James C. Wray, Suite 300, 1493 Chain Bridge Road, McLean, VA, 22101, US

(21) Appl. No.: 09/730,535

(22) Filed: Dec. 7, 2000

Related U.S. Application Data
(60) Provisional application No. 60/169,291, filed on Dec. 7, 1999.

(51) Int. Cl. G06F 15/16

(52) U.S. Cl. 709/220

(57) ABSTRACT

A method of installing a local area network by first determining a local area network to meet specific needs, including server hardware, a network operating system, a disaster recovery plan, an e-mail server, a fax server and modem sharing. Then proper hub and network cards are determined. Cabling for pre-installing by local wiring contractor is determined. Numbers of workstations to add to the local area network are chosen. Specifications of each workstation, i.e. processor speed, random access memory amount, hard drive size and operating system, are chosen. Software to be pre-installed on each system is specified. User names to the system and indicating level of security users should have on the local area network are assigned. Cost for the system chosen and costs for pre-configuring and fully testing the server and fees for pre-configuring and fully testing the workstations are established. Pre-configuring and fully testing the server. The system is ordered. The server is pre-configured and fully tested. Workstations are pre-configured and fully tested. Workstations and peripherals are fully tested. Workstations and peripherals are connected to the server and tested. Workstations and peripherals are disconnected from the server and workstations, peripherals and server are packed. The packed workstations, peripherals and server are shipped in numbered boxes. A diagram of necessary steps in setting up the local area network is provided, including which items should be pulled out of their boxes first according to the number of the box, how the server should be plugged in, how the workstations should be connected to the server, where each peripheral item including the hub, modems and printers should be placed and how they should be plugged in, when the server, workstations and peripherals should be turned on, testing the login process and insuring all workstations are pre-configured correctly and including a print out of the users order as a checklist and thereby providing by following the step-by-step instructions, a local area network that is up and running and fully functioning with all included workstations able to access the local area network and peripherals attached to the local area network and all software pre-installed.

This application claims the benefit of U.S. Provisional Application No. 60/169,291, filed Dec. 7, 1999.

### BACKGROUND OF THE INVENTION

Existing methods for networking small businesses are time consuming and costly. A need exists for an ideal and cost effective method and apparatus for networking small businesses.

### SUMMARY OF THE INVENTION

The invention includes a Virtual PC & Network Consultant web site. A main feature of this invention is a tool called The LAN Configurator. This tool allows any level users, whether novices or experts in the field of computers, to be able to configure the ideal Local Area Network to meet their specific needs. This will include the Server Hardware, Network Operating System, Disaster Recovery Plan, whether to include an e-mail Server, Fax Server or Modem Sharing, and any hardware to include accommodating such services.

The LAN Configurator also determines the proper HUB and network cards to include, and what kind of cabling the client should have pre-installed by their local electrician or wiring contractor. Wireless LANs will be used as the technology evolves and becomes an affordable, reliable alternative.

After the LAN Configurator has determined the best “Server” solution based on their needs, the clients may then add as many workstations as they would like to their LAN. They will be able to:

1. Choose the exact specifications of each workstation, i.e. Processor Type/Speed, RAM Amount, Hard Drive Size, Operating System to include, etc.

2. Specify what software should be pre-installed on each system.

3. Assign a user name to the system and indicate the level of security this user should have on the LAN.

Each workstation will then be fully configured and tested prior to delivery. Of course, the user will also have the ability to choose printers, monitors, and other various peripherals to be attached to each workstation or server.

Once their LAN has been fully configured, the client may then choose to save their configuration by either placing their LAN-IN-A-BOX order on-line via a credit card, or by using our financial services arranged through Intel®, or other financial institute available at the time of purchase, or they may view the order later, print it, etc. The cost of their LAN-IN-A-BOX order will be based on the value of the hardware and software chosen, plus the costs for pre-configuring and fully testing the Server, and an additional fee per workstation to be pre-configured and fully tested. Based on the average Network Consultant's hourly rate, it is very clear how LAN-IN-A-BOX & The LAN Configurator significantly reduce the total cost of ownerships of installing a Local Area Network.

The average amount of time spent at a client site installing, configuring and testing a new LAN based on just six (6) workstations, is about sixteen (16) hours. That's two days of having someone in an office, taking up valuable time, and costing extravagant consulting fees! Our cost through our LAN-IN-A-BOX web site and with the help of the LAN Configurator for a new server and six (6) workstations to be completely configured prior to shipment with a step-by-step setup guide and thirty (30) days of free support is much less costly. And, this is a flat-fee, never to go up! A network consultant cannot guarantee their time, especially since, when on-site, various employees like to stop and ask questions, taking up valuable time. If the consultant is not on-site, i.e. our Virtual Consultant, there is no one around to distract them!

If they place their order, the Clients will also be given the option of signing up for a “Yearly” support contract that allows the provider to remotely control and support the user's LAN via Modem and remote control software. The cost of this contract is based on 20% of the total order. The support contract would include, but is not limited to, the following services:

1. Network administrative duties, such as adding new users, deleting old users, setting up directories and user rights, etc.

2. Applying now patches made available through the Network Operating System vendor or Hardware Vendors.

3. Answering basic support questions on using their software, i.e. performing mail merges, printing various styles, creating faxes, etc.

4. Routine Preventative Maintenance on server and workstations

5. Ensuring backup is working and performing file restores upon request

Any advanced questions, such as writing macros, creating a database, installing new software, etc, are billed to the client at a pre-determined hourly rate.

In lieu of a support contract, the client may choose to use a “pay-as-you-go” service. The cost of this service is based on five (5) minute increments, whether via a telephone or a remote dial-in.

Alternatively, a client may choose the “e-mail-support” option, which allows them to post a question on the LAN-IN-A-BOX web site via e-mail. One of LAN-IN-A-BOX's highly qualified Virtual Consultants responds within one business day. A client may also choose to send an e-mail or call 1-888-LAN-N-BOX to request a price quote for performing a service, such as writing a macro, setting up a database, creating a web-page site, etc.

Each order receives thirty (30) days of free support on setup, installation and basic usability questions.

Once the order is placed, a client is able to track the progress of their order by logging back into our LAN-IN-A-BOX website, entering their User ID and Password, and searching on their order number. The various stages of the order are:

mo/dy/year: Order has been placed; ETA to ProNet

mo/dy/year: Shipment has been received at ProNet

mo/dy/year: LAN is currently being configured to client's specifications

mo/dy/year: LAN has been configured and is being burned-in and tested to ensure reliability

mo/dy/year: LAN has been completely configured and all items have been boxed up and shipped to the client with a full instructional diagram for setting up the LAN.

At any point in time, the client may call 1-888-LAN-N-BOX directly with any questions regarding their order.

The boxes are numbered according to a diagram included with every order. Once the order has been shipped to the client and the client has received it, the diagram walks the client through every necessary step of setting up their LAN. The diagram instructs:

1. Which items should be pulled out of their boxes first, according to the number of the box.

a. How the Server should be plugged in and connected and when to turn it on.

b. Where each peripheral item should be placed and how they should be plugged in, i.e., the hub, modems, printers, UPS, etc.

c. When to boot up the workstations

d. How to test the login process and ensuring all workstations were pre-configured correctly.

A printout of the user's order is included as a checklist.

The client may call 1-888-LAN-N-BOX at anytime during this process with any questions or concerns they may have installing the system. The call is free of charge.

Assuming no problems are encountered and the client follows the step-by-step instructions, their LAN will be up and running in less than a couple of hours, fully functioning with all included workstations able to access the LAN, all peripherals attached to the LAN, and all software pre-installed.

The invention provides a cost saving method of providing a business with a local area network (LAN) by first determining a network operation system (NOS) to meet the client's specific needs, including server hardware, a disaster recovery plan, an email server, a fax server, modem sharing ability, web access and/or remote access capability. The proper hub and network cards are determined. Cabling for pre-installing by local wiring contractor is determined and provided to the client. Numbers of workstations to add to the LAN are chosen by the client. Specifications of each workstation, i.e. processor speed, random access memory amount, hard drive size and operating system are chosen. Software to be pre-installed on each workstation is specified. User names to the server and indicating level of security users should have on the server are assigned. The cost for the hardware and software chosen along with costs for pre-configuring and fully testing the server and fees for pre-configuring and fully testing the workstations are established. The LAN is then ordered or saved. Upon ordering, provider purchases necessary hardware and software, the server is pre-configured and fully tested. Workstations are pre-configured and fully tested. Peripherals are fully tested. Workstations and peripherals are connected to the server and fully tested. Workstations and peripherals are disconnected from the server and all are boxed up in numbered boxes. These numbered boxes are shipped to the client along with a diagram of necessary steps for setting up the LAN, including which items should be pulled out of their boxes first according to the number of the box. The diagram instructs how the server should be plugged in, how the workstations should be connected to the server, when the server and workstations should be turned on, where each peripheral item including the hub, modems and printers should be placed and how they should be plugged in. The diagram also directs when to boot up the workstations and provides steps for testing the login process, insuring all workstations were pre-configured correctly. The shipment includes a print out of the users order as a checklist. Thereby by following the step-by-step instructions, a LAN is provided that is up and running and fully functioning with all included workstations able to access the server and the peripherals attached to the server and run all software, which was pre-installed at client's request.

A LAN is created by first choosing how many workstations will be attached to a server. Then a NOS is either chosen by the client or determined by the LAN Configurator depending on which services the client chooses to run on their server. The NOS is selected out of one of several options, depending on what is available at time of order.

The services the client would like to have installed on the server are chosen from a list, which will include, but is not limited to:

1. file and print sharing

2. run a client/server application

3. fax server option

4. modem sharing option

5. e-mail server

6. internet access capability

7. remote access capability

If all or more than options 3-7 from the list and less than fifty-one workstations were chosen, two NOS options are presented between which to choose.

If all or more than one from options 3-7 are chosen and greater than fifty users are designated, a third network operating system is presented.

If option 1 only or options 1 and 4 or options 1, 4 and 6 are chosen, a fourth network operating systems is presented.

If only options 1 and 2 are selected or if only one option from options 3-7 is selected, a fifth network operating system is presented.

These and further and other objects and features of the invention are apparent in the disclosure, which includes the above and ongoing written specification, with the claims and the drawings.

### BRIEF DESCRIPTION OF THE DRAWINGS

FIG. 1 is a flow chart for determining services and network operating system to install for the client.

FIG. 2 is a flow chart form to be filled out by client if an e-mail server was chosen.

FIG. 3 is a flow chart form to be filled out by client if modem sharing ability was chosen.

FIG. 4 is a flow chart form to be filled out by client if fax sending/receiving ability was chosen.

FIG. 5 is a flow chart form to be filled out by client if internet access option was chosen.

FIG. 6 is a flow chart for determining options for Novell NetWare 3.2.

FIG. 7 is a flow chart for determining options for Novell NetWare 4.2 or 5.1.

FIG. 8 is a flow chart for determining options for NetWare SBS v5.0.

FIG. 9 is a flow chart for determining options for NT Server v4.0.

FIG. 10 is a flow chart for determining options for Microsoft BackOffice Enterprise Edition.

FIG. 11 is a flow chart for additional options on Novell Servers (all versions except SBS).

FIG. 12 is a flow chart for additional options on Microsoft NT Server v4.0.

FIG. 13 is a flow chart for adding applicable modem card to server and adding printers, if client desires, to the LAN.

FIG. 14 is a flow chart for determining proper hub to add to LAN if needed.

FIG. 15 is a flow chart for determining proper file server hardware to be used to support NOS, etc., chosen and to then allow client to start adding workstations to their LAN.

### DETAILED DESCRIPTION OF THE PREFERRED EMBODIMENTS

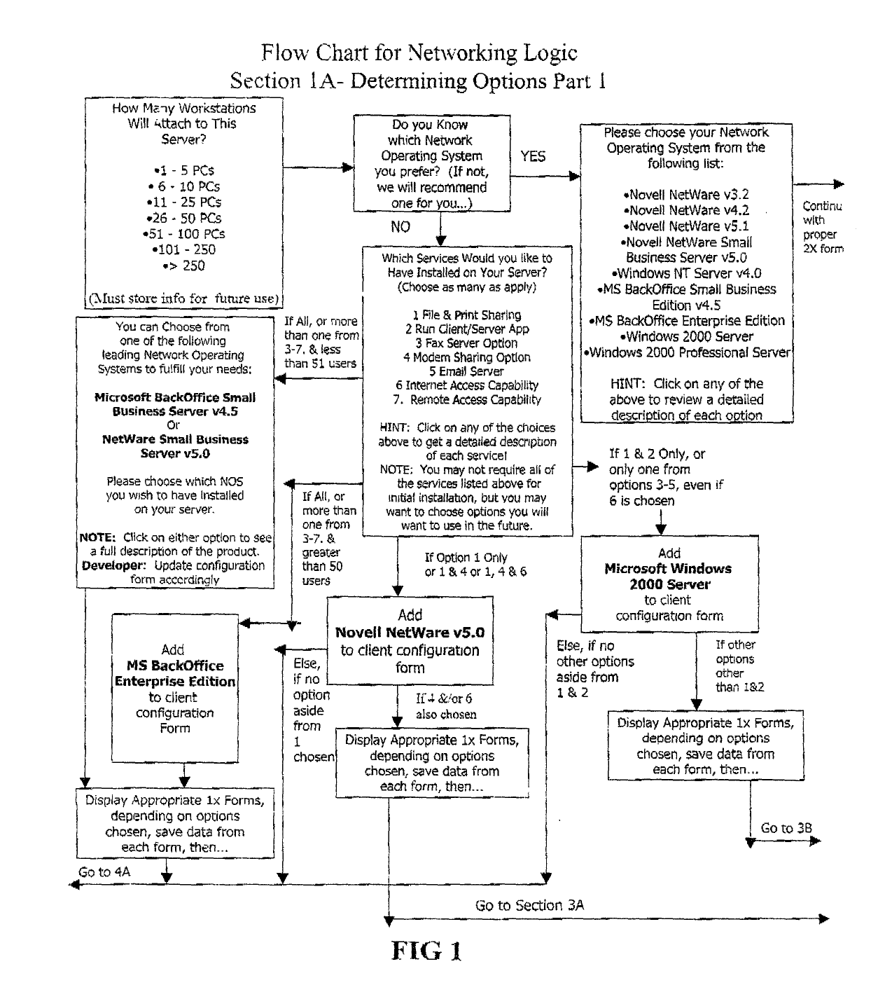

FIG. 1 is a flow chart for determining a user's options. The first question asked is how many workstations will be attached to this server. This information is stored for future use. Then a user has option to either chooses a Network Operating System (NOS) or, if the user does not have a preference, the provider selects a NOS for the user depending on which services they would like to have installed on their server, The list of services is displayed for client to choose from. If the user knows which NOS is desired, the user proceeds to the appropriate flow chart for determining further options to have installed on their NOS. Else, the remainder of the flow chart of FIG. 1 guides the user through service options to determine the best NOS for the client's needs based on the user's selected services and the number of workstations attached to the server. Some of the services include file and print sharing, run client/server applications, fax server option, modem sharing option, e-mail server, Internet access capability, and remote access capability.

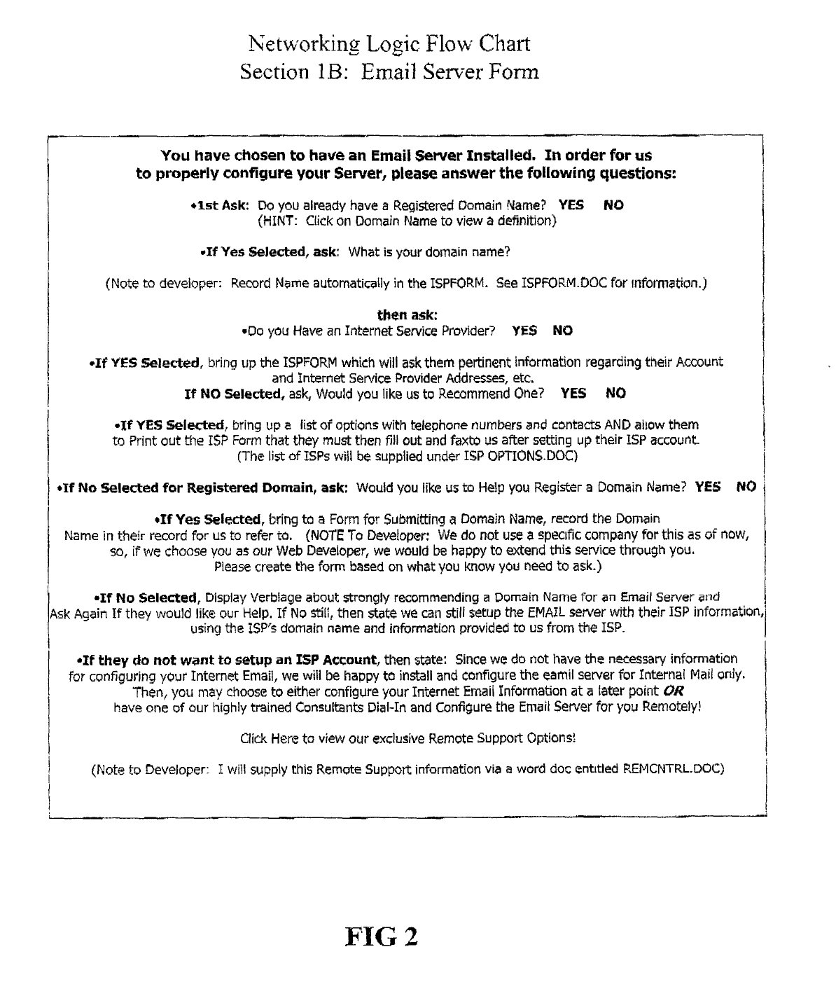

FIG. 2 is a flow chart for setting up the server with an e-mail server. Several questions need to be asked in order to properly configure the server as an e-mail server. First, the provider needs to know whether the user already has a registered domain name. The next question asked is whether the user has an Internet Service Provider (ISP). If either of these questions is answered negatively, the user is given the option of having the provider obtain a domain name and/or an ISP for the user.

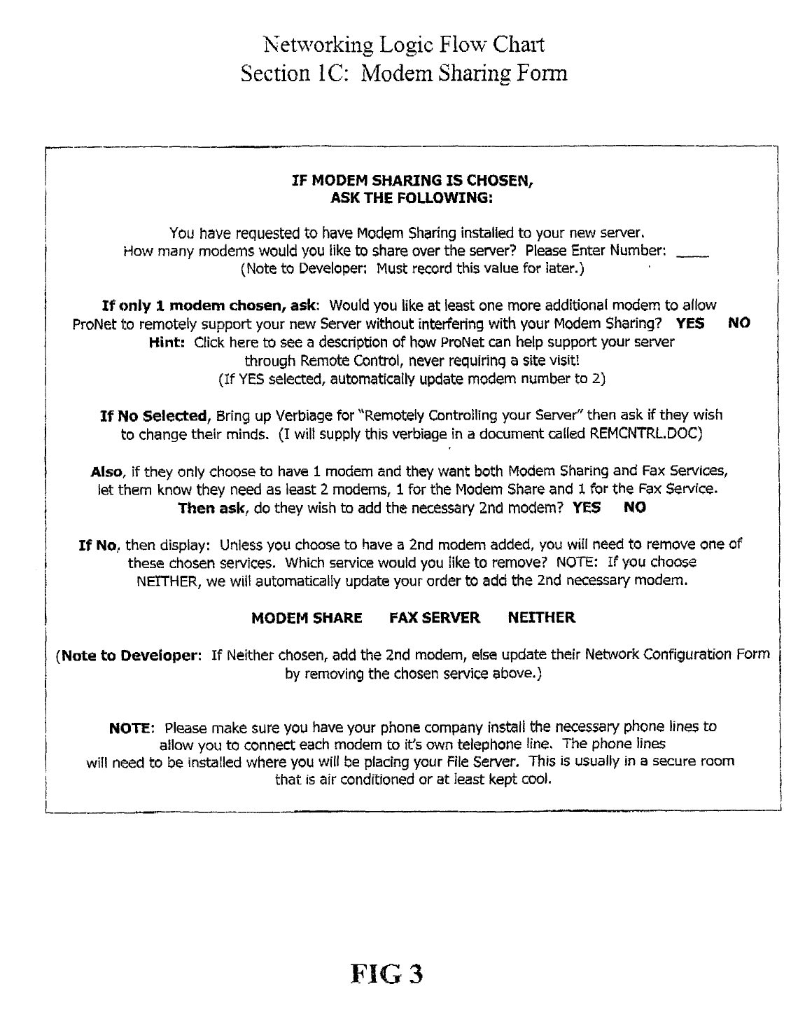

FIG. 3 is a flow chart for setting up the server with modem sharing capabilities. Several questions need to be asked in order to properly configure the modem sharing. First, the provider needs to know how many modems the user would like to have shared. If only 1 is chosen, provider then asks whether user would like to have remote support option, and, if so, ask if user would like to add a second modem. Also, if adding a fax server along with modem sharing, form instructs user they must have at least 2 modems to properly support both features, else one feature must be removed. If client chooses to have both features, modem number is automatically updated to 2 if they had previously only chosen 1.

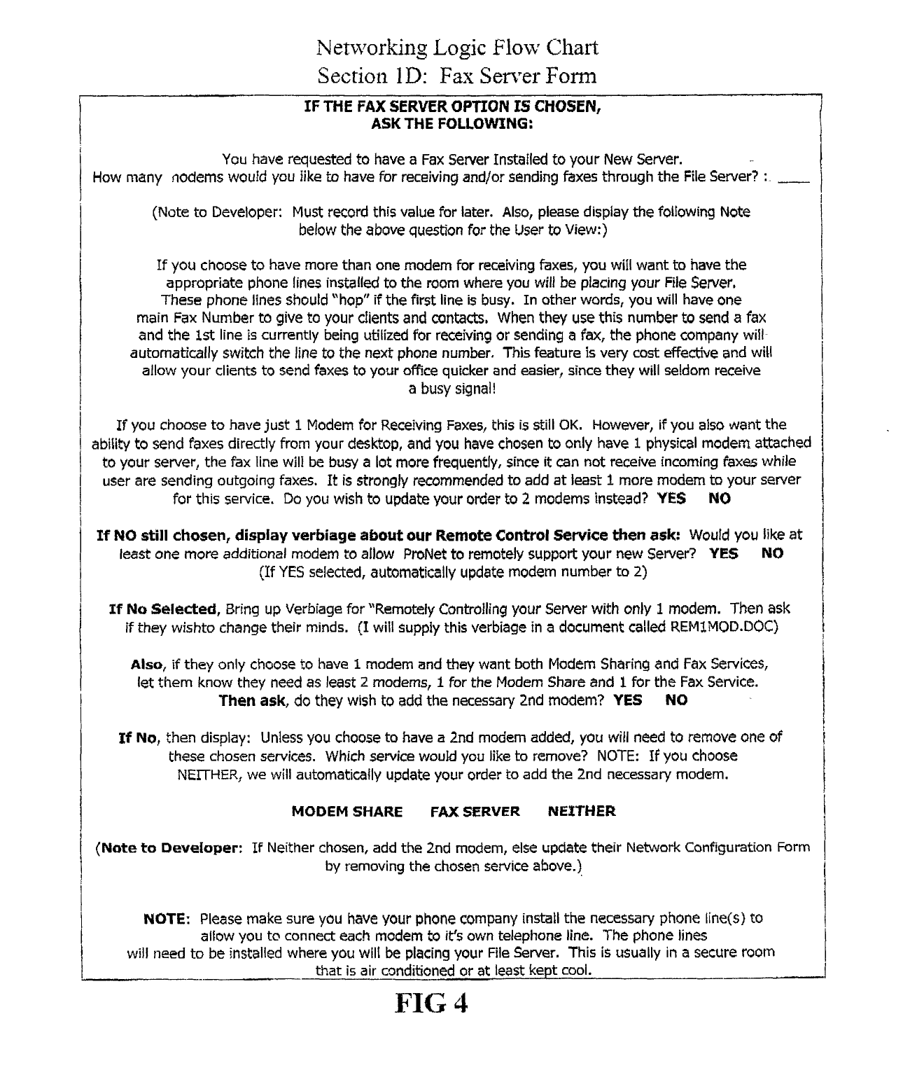

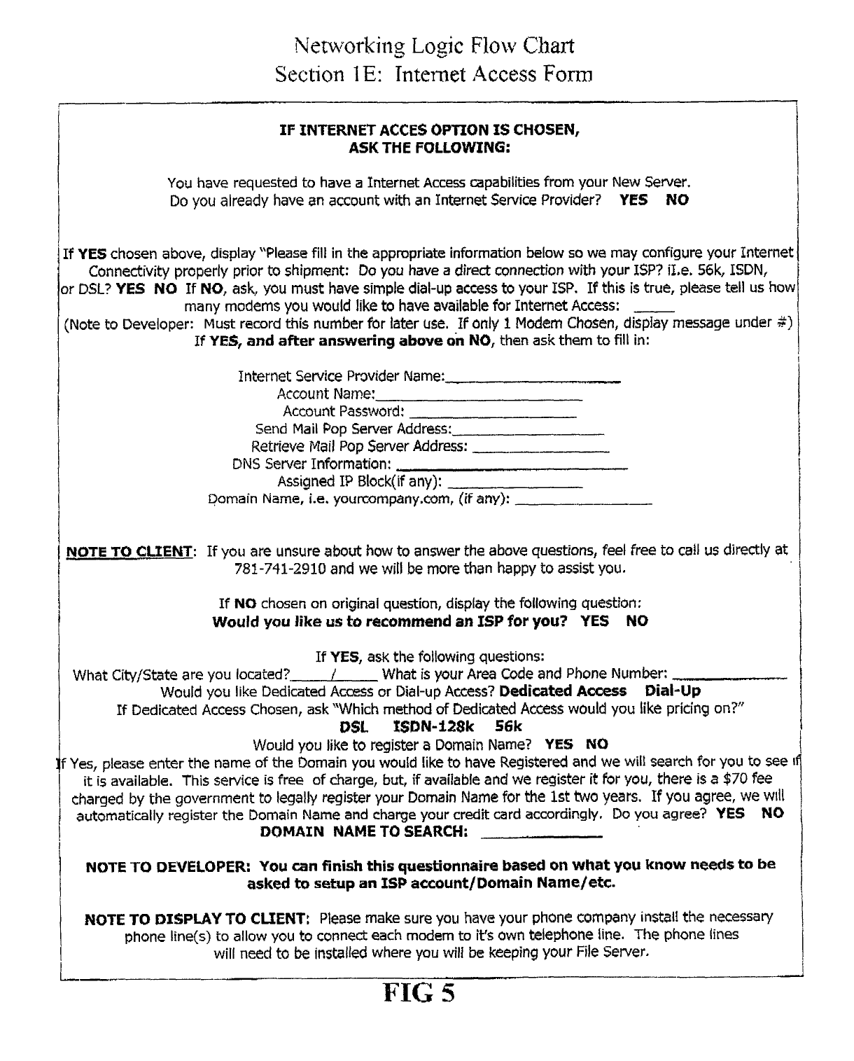

FIG. 4 is a flow chart for setting up the server with a fax server. Several questions need to be asked in order to properly configure the fax server. First, the provider needs to know how many modems the user would like to have shared. If only 1 is chosen, provider then asks whether they plan on using the fax server for sending and receiving. If yes, form instructs the user they really need 2 modems to properly support the fax server and gives user option of changing number of modems from 1 to 2. If only using fax server for either sending or receiving, form also displays information to user asking if they would like to have remote support option, and, if so, ask if user would like to add a second modem. Also, if adding a modem sharing along with fax server, form instructs user they must have at least 2 modems to properly support both features, else one feature must be removed. If client chooses to have both features, modem number is automatically updated to 2 if they had previously only chosen 1.

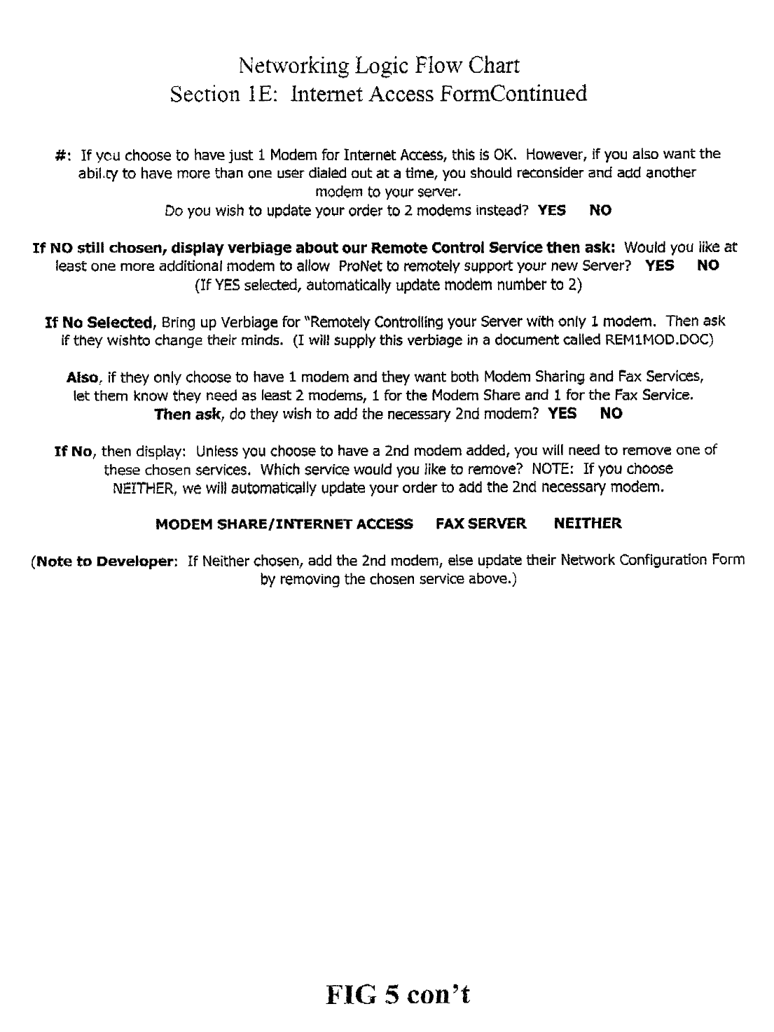

FIG. 5 is a flow chart for setting up the server to have Internet access capabilities. Several questions need to be asked in order to properly configure the server for Internet access. First, the provider needs to know whether the user already has a an account with an ISP and, if so, the form asks for the pertinent information about the ISP. If no, form gives user the option of having provider recommend one for them. The form also asks whether the user has a registered domain name. If answered negatively, the user is given the option of having the provider obtain a domain name and/or an ISP for the user.

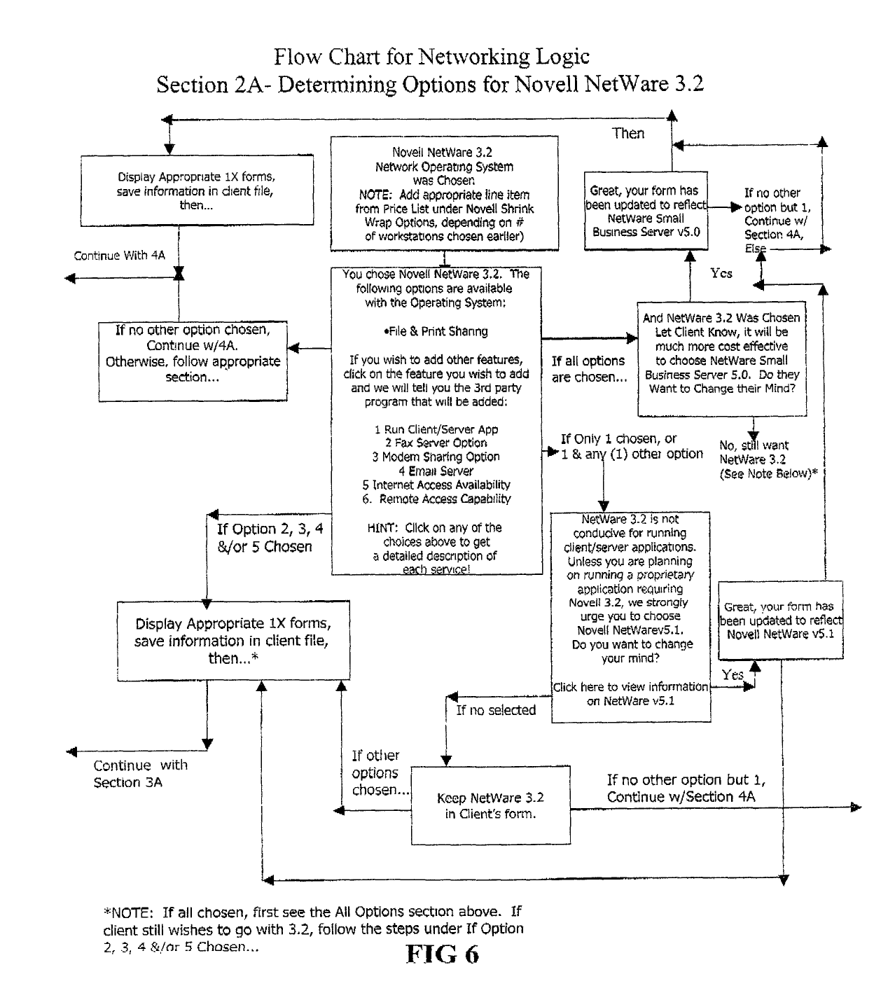

FIG. 6 is a flow chart for a user who selects NetWare 3.2. File and print sharing is only option inherent in this NOS. The user is given the option to add other features using third party software. The user may be asked more in-depth questions for their desired options in order for the provider to properly configure the system to the user's exact specifications & requirements.

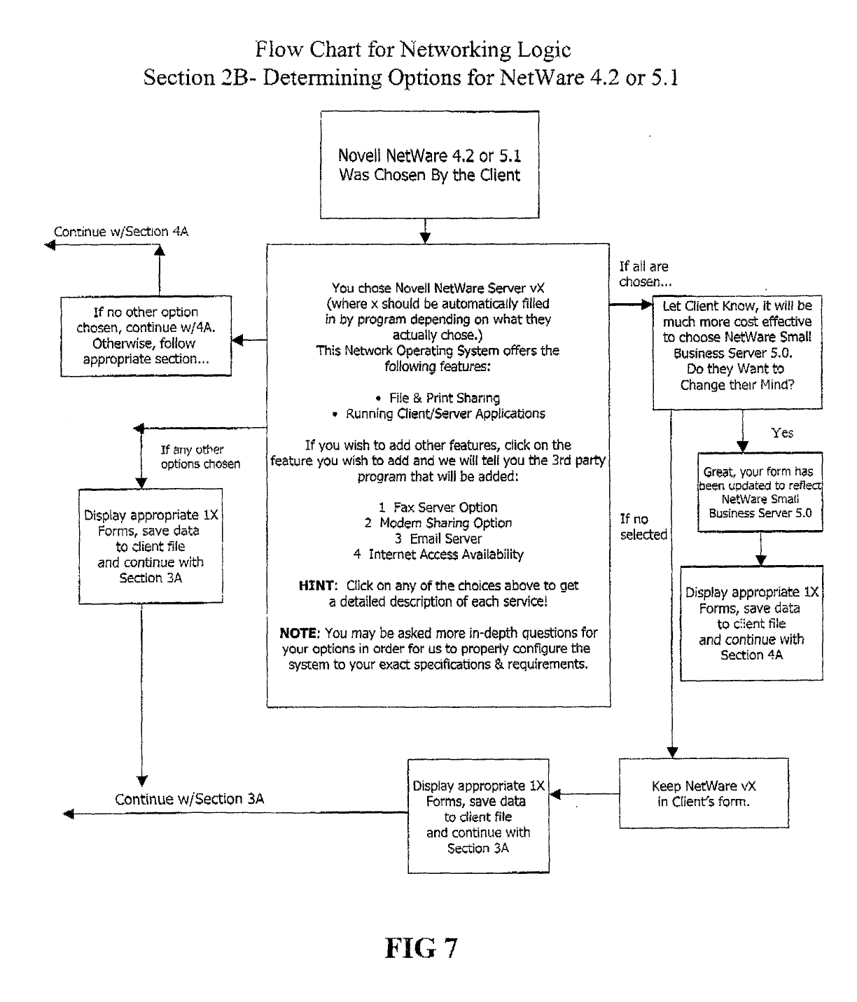

FIG. 7 is a flow chart for a user who selects NetWare 4.2 or 5.0 as the NOS. File and print sharing and running a client/server application are available with this NOS. The user is given the option to add other features using third party software. The user may be asked more in-depth questions for their desired options in order for the provider to properly configure the system to the user's exact specifications & requirements.

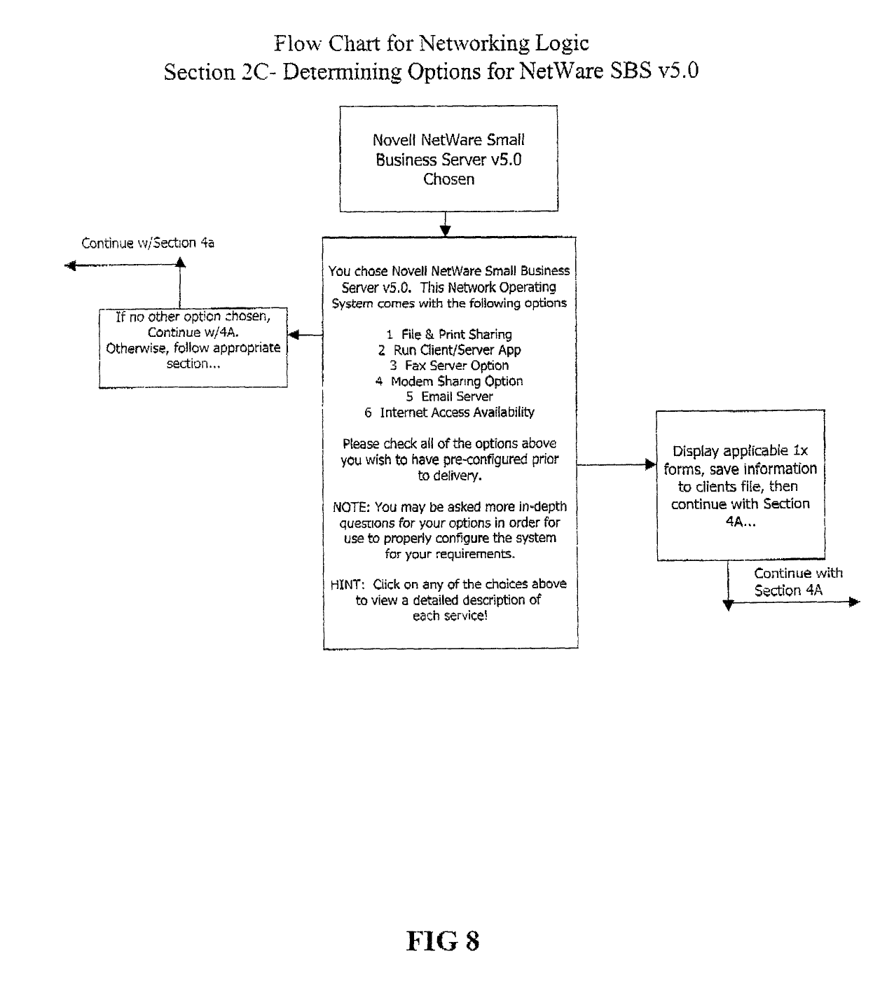

FIG. 8 is a flow chart for a user who selects Small Business Server (SBS) v5.0. The SBS v5.0 server includes the following options: file and print sharing, run client/server applications, fax server option, modem sharing option, e-mail server, and Internet access availability. The user may request to have any combination of these options pre-configured prior to delivery. The user is asked more in-depth questions about the selected options in order for the provider to properly configure the system for the user's requirements.

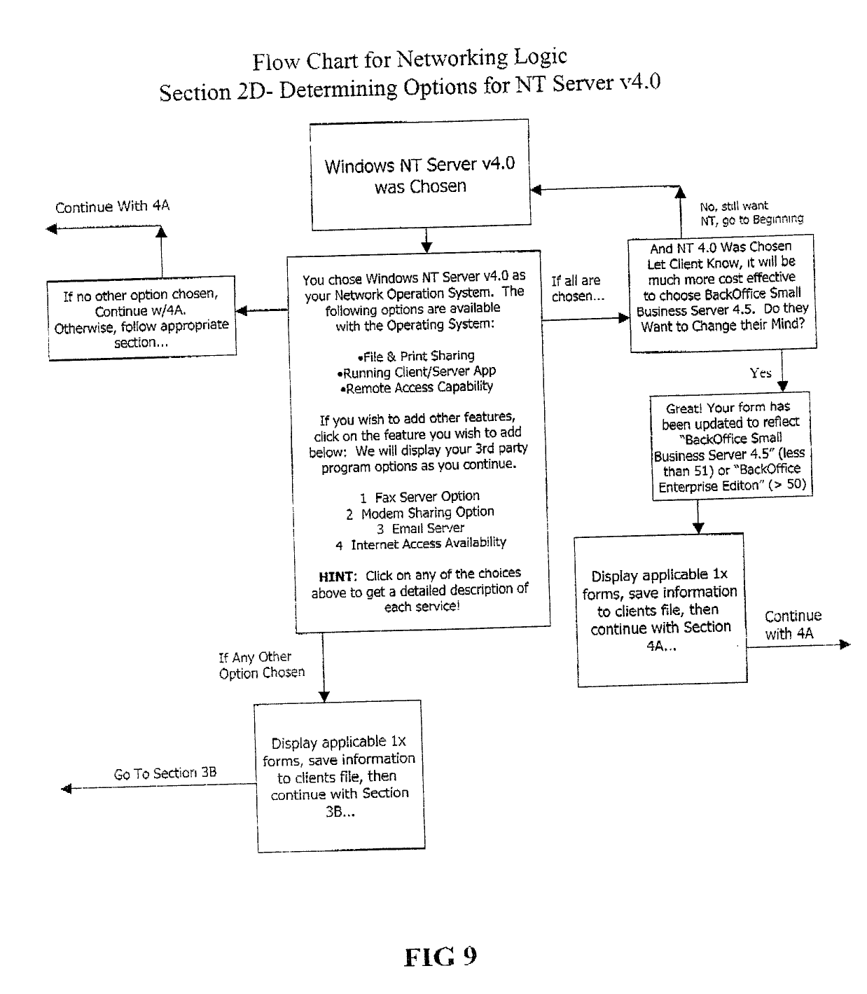

FIG. 9 is a flow chart for determining a user's options for the Windows NT Server v4.0. The Windows NT Server v4.0 includes the following options: file and print sharing, running a client/server application and remote access capabilities. The user may select to have other options added by third party software. The user may be asked more in-depth questions for their desired options in order for the provider to properly configure the system to the user's exact specifications & requirements.

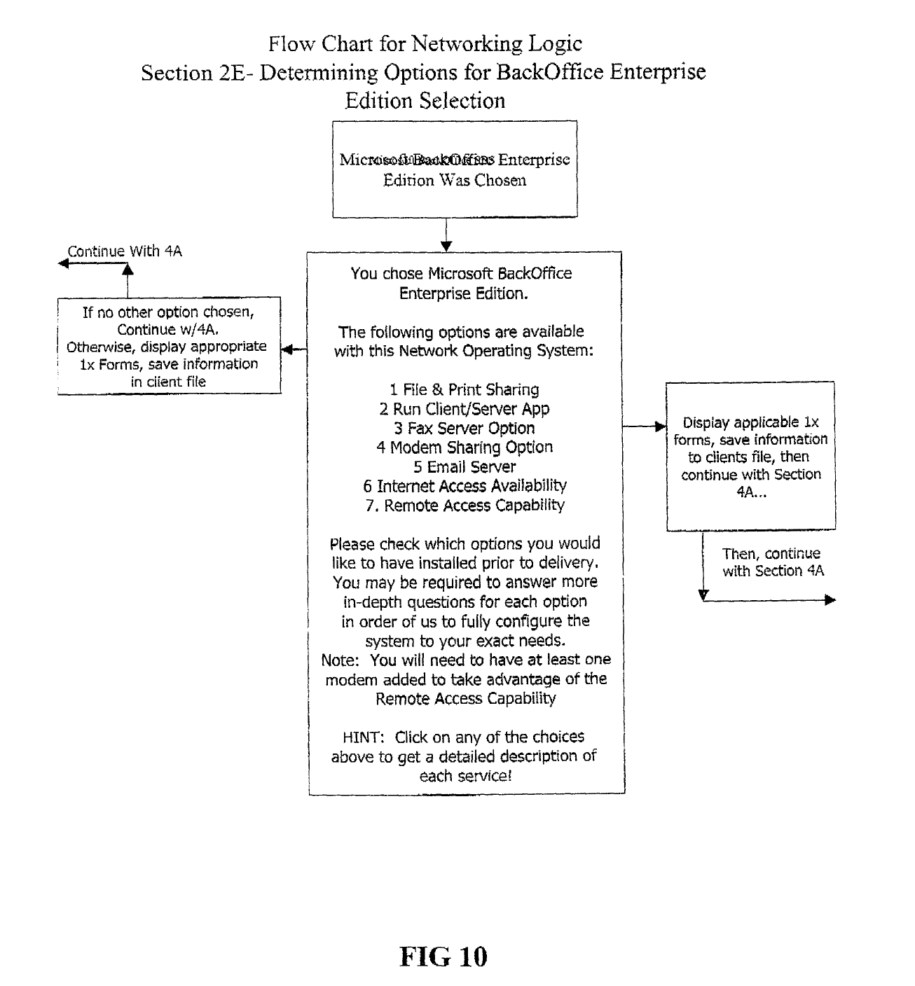

FIG. 10 is a flow chart for determining a user's options for the Microsoft BackOffice Enterprise Edition. This NOS includes the following options: file and print sharing, running a client/server application, fax server option, modem sharing, email server option, internet access capabilities and remote access capabilities. The user may be asked more in-depth questions for their desired options in order for the provider to properly configure the system to the user's exact specifications & requirements.

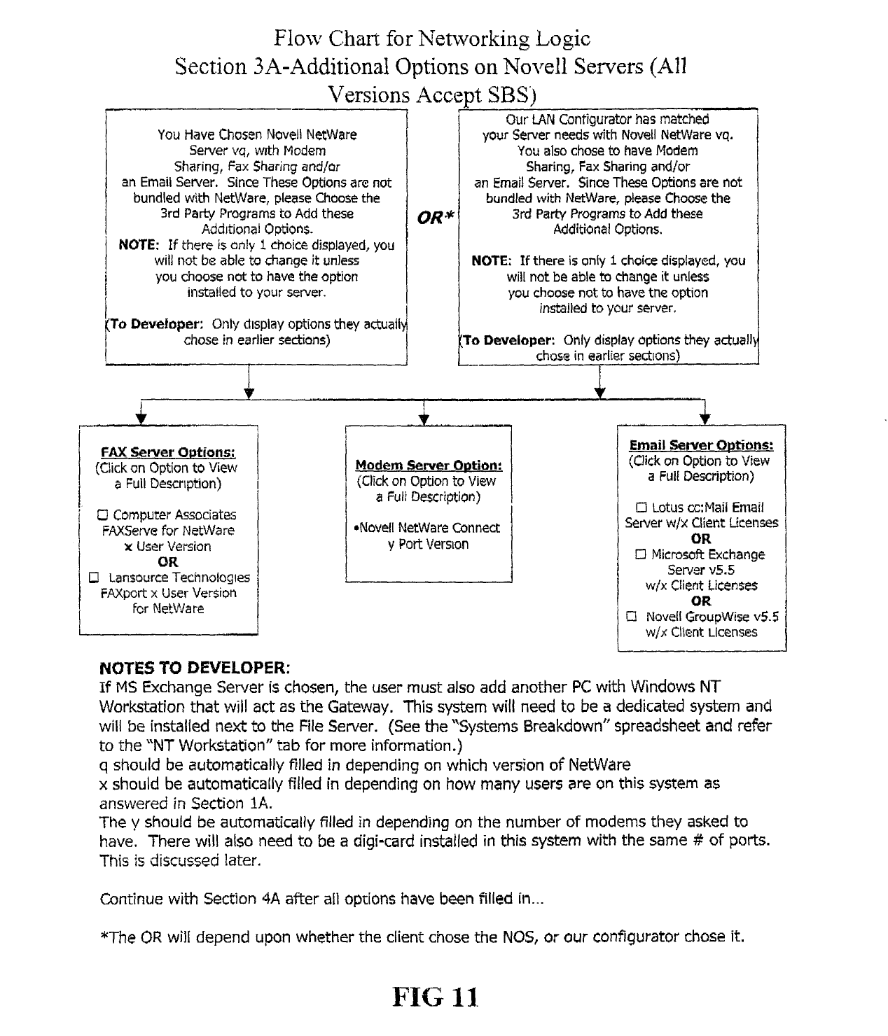

FIG. 11 is a flow chart for allowing user to select the desired third party solution for the additional options they chose to have under Novell NetWare, applicable to all versions except Small Business Server. Fax server options, modem server options, email server, and remote access capabilities are not bundled with Netware, so at this point the user selects third party programs to add any of these additional options. Only options for the services previously selected by the user are displayed. q represents the version of NetWare. x represents the number of users on the system, as answered in the flow chart of FIG. 1. y represents the number of modems the user requested. A modem card is installed in the server to match the number of ports with the number of modems requested by user.

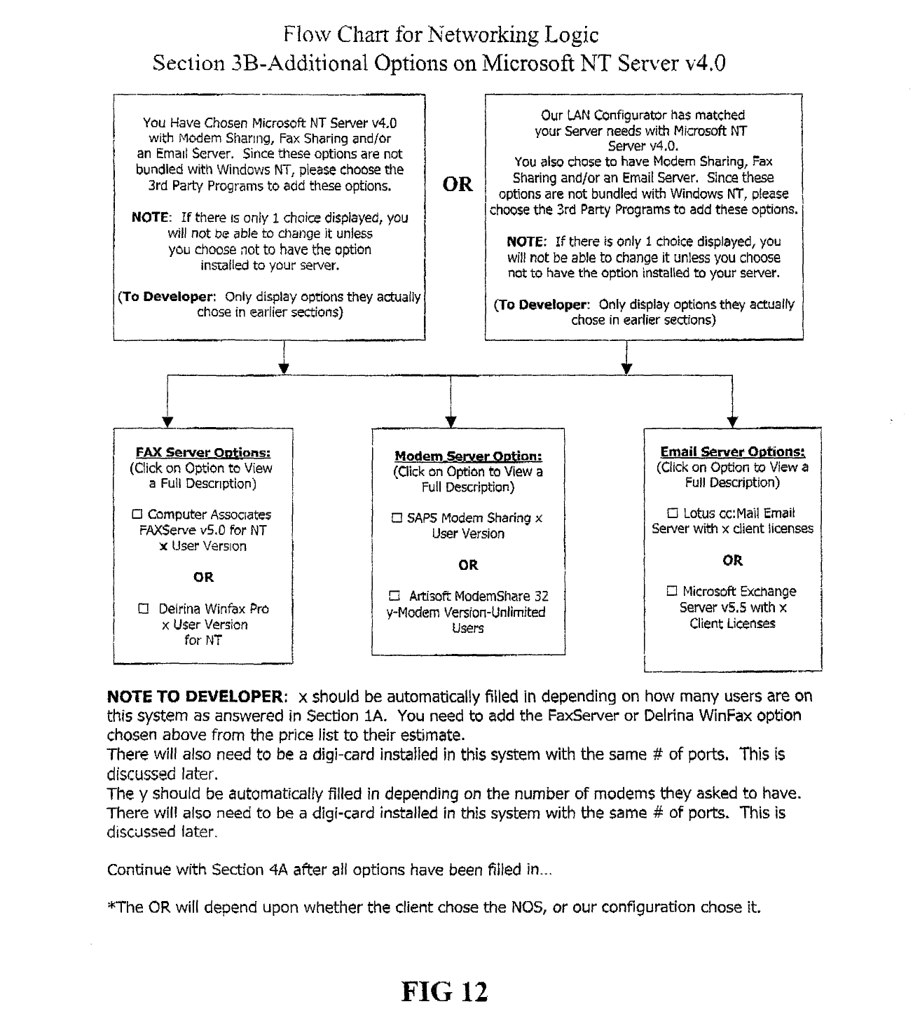

FIG. 12 is a flow chart for allowing user to select the desired third party solution for the additional options they chose to have under Microsft Windows NT 4.0. Fax server options, modem server options, and email server capabilities are not bundled with this NOS, so at this point the user selects third party programs to add any of these additional options. Only options for the services previously selected by the user are displayed. x represents the number of users on the system, as answered in the flow chart of FIG. 1. y represents the number of modems the user requested. A modem card is installed in the server to match the number of ports with the number of modems requested by user.

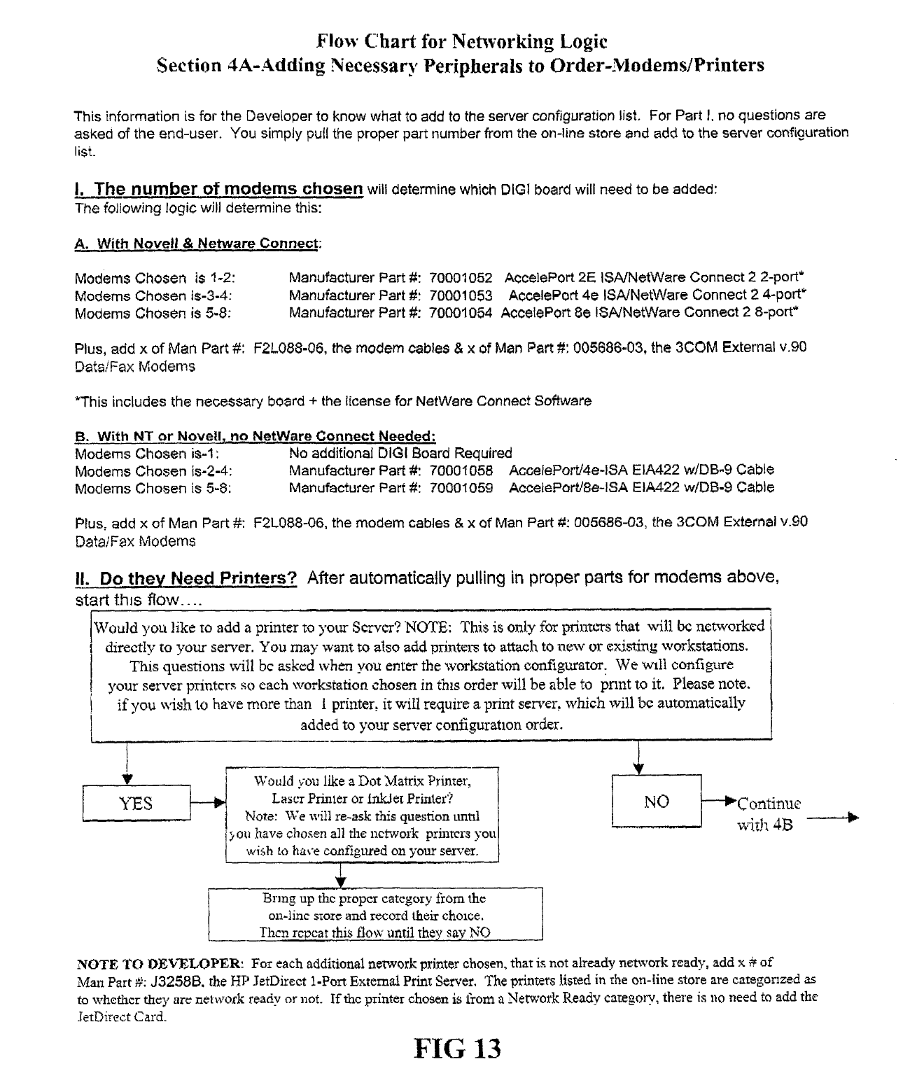

FIG. 13 is a flow chart for determining the proper modem card to be installed in the server to support the number of modems requested by the user. It then allows the user to choose whether to add printers to their LAN and displays a list of options to choose from.

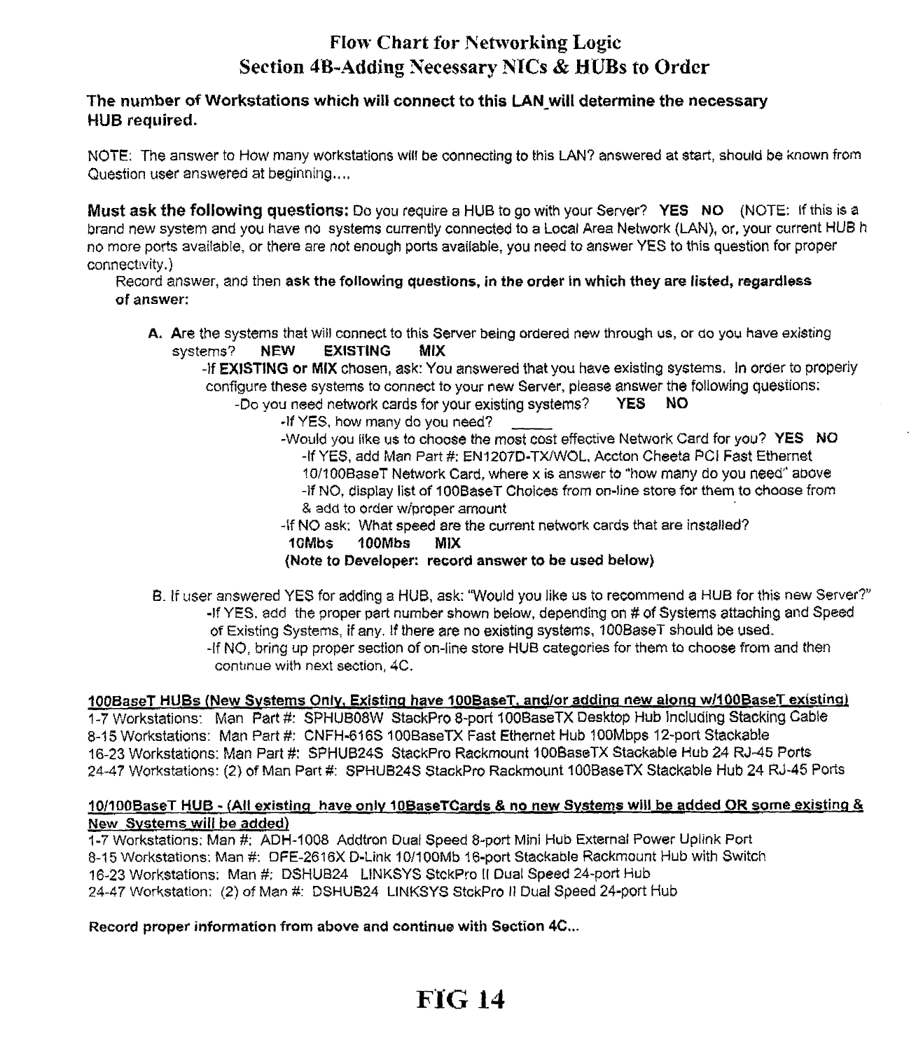

FIG. 14 is a flow chart for determining the proper hub to be included with the LAN as well as the type of Network Cards to include.

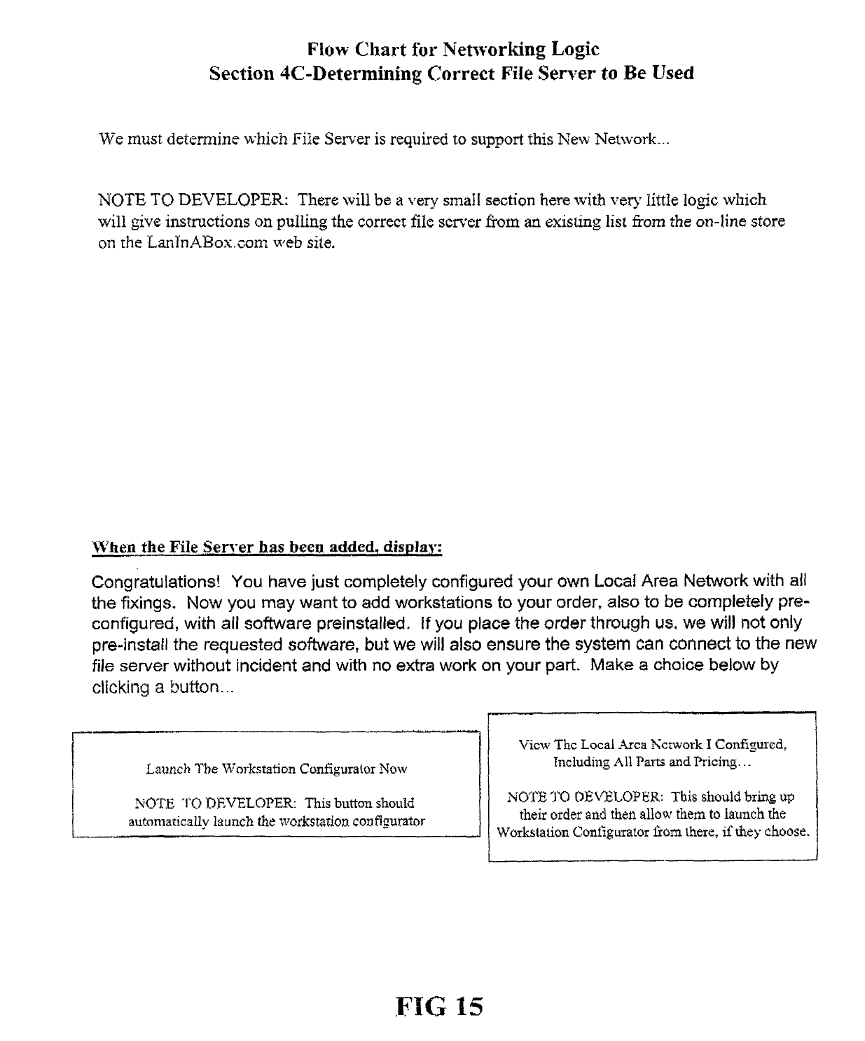

FIG. 15 is a flow chart for determining the actual file server to be used to support the selected NOS and services. The file server options will be supplied to the program from a list, which will change as the available options in the industry change. The form will then guide the user to continue with the order by adding necessary workstations to be attached to the LAN.

While the invention has been described with reference to specific embodiments, modifications and variations of the invention may be constructed without departing from the scope of the invention, which is defined in the following claims.

I claim:

1. A method of installing a local area network, comprising selecting server hardware, determining a network operating system to meet specific needs, which may include an email server, a fax server, modem sharing ability, internet access ability, remote access, etc., determining proper hub and network cards to include, determining cabling for pre-installing by local wiring contractor, choosing numbers of workstations to add to the local area network, choosing the specifications of each workstations, i.e. processor speed, random access memory amount, hard drive size and operating system, specifying software to be preinstalled on each system, assigning user names to the system and indicating level of security users should have on the local area network, establishing a cost for the system chosen and costs for pre-configuring and fully testing the server and fees for pre-configuring and fully testing the workstations, ordering the system, pre-configuring, pre-installing software and fully testing a server, pre-configuring, pre-installing software and fully testing workstations, connecting workstations to the server and pre-testing the workstations connected to the server, disconnecting the workstations from the server and packing the workstations and server, shipping the packed workstations and server in numbered boxes, providing a diagram of necessary steps in setting up the local area network, providing a list of which items should be pulled out of their boxes first according to the number of the boxes, providing instructions for how the server should be plugged in, how the workstations should be connected to the server, when the server and workstations should be turned on, where each peripheral item including the hub, modems and printers should be placed and how they should be plugged in, providing directions of when to boot up the workstations and providing testing the login process instructions and providing instructions for insuring that all workstations are pre-configured correctly and including a print out of the users order as a checklist and thereby providing by following the instructions and the directions, a local area network that is up and running and fully functioning with all included workstations able to access the local area network and peripherals attached to the local area network and all software pre-installed.

2. The method of claim 1, wherein the determining of a network operating system further comprises selecting one of several network operating systems. The list will vary depending on what is available at given time.

3. A method of creating a local area network comprising of choosing how many workstations will be attached to a server, choosing a network operating system by determining what kinds of services are required by user, configuring the network operation system as an e-mail server if desired by determining a registered domain name and determining an Internet service provider if necessary. The list of services user choose from includes:
a. file and print sharing
b. run client/server application
c. fax server option,
d. modem sharing option,
e. email server,
f. Internet access capability, and
g. remote access capability

4. The method of claim 3, further comprising if all or more than one from options c-g from the list and less than fifty-one workstations are designated, determining first and second network operating systems between which to choose.

5. The method of claim 3, further comprising if all or more than one from options c-g are chosen and greater than fifty users are designated, determining a third network operating system.

6. The method of claim 3, further comprising if option a only or options a and d or options a, d and f are chosen, determining a fourth network operating system.

7. The method of claim 3, further comprising if only options a and b are selected or if only one from options c-g is selected, determining a fifth network operating system.

8. The method of claim 3, wherein the further comprising if all or more than one from options c-g from the list and less than fifty-one workstations are designated, determining first and second network operating systems between which to choose, if all or more than one from options c-g are chosen and greater than fifty workstations are designated, determining a third network operating system, if option a only or option a and d or option a, d and f are chosen, determining a fourth network operating system, or if only options a and b are selected or if only one option from options c-g is selected, determining a fifth network operating system.

9. The method of claim 3, further comprising pre-configuring, pre-installing software and fully testing a server, pre-configuring, pre-installing software and fully testing workstations, connecting workstations and peripherals to the server and pre-testing the workstations and peripherals connected to the server, disconnecting the workstations and peripherals from the server and packing the workstations, peripherals and server, shipping the packed workstations, peripherals and server in numbered boxes.

10. The method of claim 9, further comprising providing a diagram of necessary steps in setting up the local area network, providing a list of which items should be pulled out of their boxes first according to the number of the boxes, providing instructions for how the server should be plugged in, where each peripheral item including the hub, modems and printers should be placed and how they should be plugged in, how the workstations and peripherals should be connected to the server, when the server, workstations and peripherals should be turned on, and providing instructions for testing the login process and providing instructions for insuring all workstations are pre-configured correctly and including a print out of the users order as a checklist and thereby providing by following the instructions and the directions, a local area network that is up and running and fully functioning with all included workstations able to access the local area network and peripherals attached to the local area network and all software pre-installed.

11. A method of installing a local area network, comprising pre-configuring, pre-installing software and fully testing a server, pre-configuring, pre-installing software and fully testing workstations, connecting workstations and peripherals to the server and pre-testing the workstations and peripherals connected to the server, disconnecting the workstations and peripherals from the server and packing the workstations, peripherals and server, shipping the packed workstations, peripherals and server in numbered boxes, providing instructions for how the server should be plugged in, where each peripheral item including the hub, modems and printers should be placed and how they should be plugged in, how the workstations and peripherals should be connected to the server, when the server, workstations and peripherals should be turned on, and providing instructions for testing the login process and providing instructions for insuring all workstations are pre-configured correctly and including a print out of the users order as a checklist and thereby providing by following the instructions and the directions, a local area network that is up and running and fully functioning with all included workstations able to access the local area network and peripherals attached to the local area network and all software pre-installed.
